(19) United States
(12) Patent Application Publication
(10) Pub. No.: US 2002/0118176 A1
(43) Pub. Date: Aug. 29, 2002

(54) Portable computer with chord keyboard

(75) Inventor: Amnon Ribak, Yuvalim (IL)

Correspondence Address: DARBY & DARBY P.C., 805 Third Avenue, New York, NY, 10022, US

(73) Assignee: INTERNATIONAL BUSINESS MACHINES CORPORATION

(21) Appl. No.: 09/794,583

(22) Filed: Feb. 27, 2001

Related U.S. Application Data
(60) Provisional application No. 60/237,653, filed on Oct. 3, 2000.

(51) Int. Cl. G09G 5/00

(52) U.S. Cl. 345/169

(57) ABSTRACT

A computing device, including a processor, a screen, and at least one chord keyboard. The screen is coupled to be driven by the processor to display data to a user of the device, and is arranged so as to be viewable by a user of the device while holding the device with both hands, one at either side of the screen. The at least one chord keyboard comprises keys, and is fixed to a side of the screen in such a position as to be gripped by the user while holding the device so as to view the screen, and is coupled to provide input to the processor responsive to pressure exerted on the keys by the user.

### CROSS-REFERENCE TO RELATED APPLICATIONS

This application claims the benefit of U.S. Provisional Patent Application No. 60/237,653, filed on Oct. 3, 2000, which is incorporated herein by reference.

### FIELD OF THE INVENTION

The present invention relates to the field of inputting data to computers, particularly methods and apparatus for inputting information and control signals to a portable computer.

### BACKGROUND OF THE INVENTION

Portable computing devices such as laptop computers typically contain an input device for a user to communicate with them, and to input information and control signals thereto. Examples of such input devices include a keyboard; a touch screen with stylus and character recognition software; and a microphone and voice recognition software.

Laptop computers typically fold open to expose an internal keyboard and display screen. The regular, fully functional keyboard requires approximately 100 keys each the width of a finger. These size requirements of the keyboard in effect double the size of the portable computer. To use the keyboard of a laptop computer, the keyboard is generally opened and rested on a surface at least the size of the keyboard. Where space is limited, or in the absence of a flat surface, for when example sitting on a bus, use of conventional laptop computers becomes impractical. Use of a conventional laptop computer while standing, without a surface on which to rest the computer, is virtually impossible.

Some portable computing devices use a touch screen and stylus to input information. The stylus is typically used with either character recognition software, such as Graffity in the Palm Pilot™ family of products, or with a “soft” keyboard, i.e., an image of a keyboard shown on a touch screen, enabling the user to select the desired characters. Input of characters using a stylus is slow and relatively inaccurate, and thus is not an effective substitute for typing.

Voice activation and dictation systems require substantial computing power and as yet are still not entirely accurate. Furthermore, while voice input of data may be practical in private areas such as a private office or the home, it is not suitable for public areas where the background noise level is high, or where privacy is required.

The chord keyboard is an alternative to the standard “qwerty” keyboard. The chord keyboard is a compact input device, usually for one-handed operation, that replicates the functions of a full-size keyboard, with fewer keys than the full-size keyboard. On a chord keyboard there are a limited number of keys, often, although not always, one for each finger. As in a normal keyboard, pressing a single key makes one character. Chording, the pressing of combinations of keys simultaneously produces different characters. Ease of use, accuracy and typing speed are increased and muscle strain is reduced when using a chord keyboard as compared to a regular keyboard.

The state of the art of chord keyboards is believed to be represented in U.S. Pat. Nos. 5,017,030; 4,360,892; and 5,432,510, incorporated herein in their entirety by reference.

U.S. Pat. No. 5,017,030 to Crews discloses a two-handed peripheral chord keyboard for connection to a computing device.

U.S. Pat. No. 4,360,892 to Endfield describes a word processing device designed to be held in the palm of one hand, and which comprises a miniature screen of limited functionality, and four finger keys and at least one thumb key for use by the other hand, that act as a chord keyboard for inputting data to the device. The word processing device disclosed by Endfield is not suitable for holding with both hands while in use, and data cannot be inputted into the device by the same hand which is holding the device.

U.S. Pat. No. 5,432,510 to Matthews describes a computing device designed to be held in the palm of one hand, and which comprises a miniature screen of limited functionality, and keys for use by the holding hand, that act as a chord keyboard for inputting data to the device. The device disclosed by Matthews has very limited computing functions and is described as being a data management device in the field of computer peripheral equipment. Data inputted into the device by a user is usually uploaded to a computer. Although data can be inputted into Matthews's device by the hand which is holding the device, it is not suitable for holding with both hands while in use, nor is it suitable for inputting data by both hands while holding the device.

The Bat Chord Keyboard by NanoPAc, Inc. (http://www.nanopac.com/keyboard.htm) is a commercially available example of a chord keyboard that replaces a conventional keyboard. The Twiddler by Handykey Corp. (http://www.handykey.com/over.html) is a commercially available example of a combined chord keyboard and mouse, that replaces both of these devices. Both the Bat Chord Keyboard and the Twiddler are peripheral devices that connect to computers and are not standalone functional devices.

The disclosures of each and every one of the publications mentioned in this section and in other sections of the specification, are incorporated herein by reference, each in its entirety.

### SUMMARY OF THE INVENTION

The present invention seeks to provide a novel input mechanism and method for a portable computing device, which can be operated comfortably while holding the device in two hands and viewing a full-size display screen of the device. The portable computing device, constructed and operative in accordance with a preferred embodiment of the present invention, comprises the display screen and at least one chord keyboard input assembly, attached at one or both sides of the display and configured with its keys at least partially at the rear of the device. This configuration allows the user to hold the device in both hands, while standing or sitting, with the thumbs adjacent to the screen and the remaining four figures behind the screen and able both to support the screen and operate the keys located there. While chord keyboard designs known in the art can ergonomically accommodate only a very small display, and thus very limited functionality, the novel configuration of the present invention enables full-size, full-function computers to be used with chord keyboards in a way that has been hitherto unknown.

The input mechanism and method described herein may replace traditional input methods to a computing device. In accordance with a preferred embodiment of the present invention, the computing device does not have an input mechanism, such as a regular keyboard, voice recognition, and stylus or touch-screen, in addition to the chord keyboard. In an alternative embodiment, the computing device does have such an input mechanism in addition to the chord keyboard.

In a preferred embodiment, the processor, and preferably other components of the computing device, are located behind the screen, so that the size of the device does not have to substantially exceed the dimensions of the screen.

In accordance with a preferred embodiment of the present invention, in addition to the input keys positioned to be pressed by a user's fingers behind the screen, the chord keyboard comprises at least one input key, button or other control, such as a pointing device, positioned at the front of the computing device to be pressed by the user's thumb.

In a preferred embodiment, the chord keyboard comprises a plurality of keys or buttons, each of which is typically positioned to be preferentially pressed by a particular respective digit of the user. Preferably, a single key is positioned to be preferentially pressed by each particular respective digit. In an alternative embodiment, more than one key is positioned to be preferentially pressed by each particular respective digit.

In a preferred embodiment, the computing device comprises two chord keyboards positioned one at either side of the device. The device can be comfortably held in both hands so as to view the screen, by gripping the chord keyboards one in each hand. Each of the two chord keyboards may be used independently as input devices for the processor, which will typically increase the rate of input to the processor. Alternatively, the two chord keyboards may chord in coordination such that the pressing of a combination of up to ten keys simultaneously generates an input representing different characters or instructions, which allows a much greater range of characters and symbols to be input to the processor.

Additionally or alternatively, one of the two chord keyboards may be used to generate signals representing alphanumeric characters, while the second chord keyboard generates processing or control signals, in an analogous manner to the “shift”, “alt” and “control” keys on a standard keyboard.

In another preferred embodiment, the computing device comprises a single chord keyboard positioned on one side of the device, for input to the processor by a single hand. To comfortably hold the device in both hands, so as to view the screen, the device preferably also comprises a handgrip located on the opposite edge of the device from the chord keyboard, for gripping with the other hand. The handgrip is typically ergonomically designed for comfortable holding of the device. The handgrip may also comprise a pointing device, which functions like a mouse for manipulating a cursor on the screen. The pointing device may comprise any pointing device known in the art, such as a joystick, a thumb button (a depressed button for control by rotational pressure of the thumb), or a pressure-sensitive knob, such as the TrackPoint device provided in some portable computers, such as the IBM ThinkPad™.

In a preferred embodiment, the at least one chord keyboard may be slidable, or otherwise movable, along the edge of the computing device, so as to be positioned at a desired position relative to the screen. Additionally or alternatively, the chord keyboard may be attachable to and detachable from the device.

A computing device constructed and operative in accordance with a preferred embodiment of the present invention, does not have to be laid on a flat surface for use, and may be used while being held. It is appreciated that the lower edge of the device may be rested on a support to minimize muscle strain to a user. The lower edge of the device may have a protective coating, to protect against damage to the device.

In a preferred embodiment, the device may also comprise one or two armrests, attached to the edges of the device and positioned on either side of the screen, to support the lower arms, wrists or hands of a user holding the device at the chord keyboard or handgrip. The armrests may be slidable, or otherwise movable, along the edge of the computing device, so as to be positioned at a desired position relative to the chord keyboard or handgrip. Additionally or alternatively, the armrests may be attachable to and detachable from the device.

There is thus provided in accordance with a preferred embodiment of the present invention, a computing device, including a processor, a screen, which is coupled to be driven by the processor to display data to a user of the device, and which is arranged so as to be viewable by a user of the device while holding the device with both hands, one at either side of the screen, and at least one chord keyboard comprising keys, which is fixed to a side of the screen in such a position as to be gripped by the user while holding the device so as to view the screen, and which is coupled to provide input to the processor responsive to pressure exerted on the keys by the user.

Further in accordance with a preferred embodiment of the present invention, the at least one chord keyboard comprises two chord keyboards, one at either side of the screen.

Additionally in accordance with a preferred embodiment of the present invention, the device also includes a handgrip, fixed to the side of the screen opposite the chord keyboard.

Still further in accordance with a preferred embodiment of the present invention, the device also comprises at least one armrest, which is fixed to a side of the screen in such a position that the user can rest an arm, wrist or hand thereupon, while gripping the at least one chord keyboard.

Additionally in accordance with a preferred embodiment of the present invention, the at least one chord keyboard is configured to be detached from the screen and reattached thereto by the user.

Also in accordance with a preferred embodiment of the present invention, the at least one chord keyboard is configured to be moved along an edge of the screen by the user, so as to provide input to the processor from multiple positions along the edge.

There is also provided, in accordance with another preferred embodiment of the present invention, a computing device, including a processor, adjacent first and second screens, having respective inner and outer edges, wherein the screens are connected to one another at the inner edges thereof, wherein the first and second screens are coupled to be driven by the processor to display data to a user of the device and are arranged so as to be viewable by the user while holding the device with both hands, one at either side of the device at the outer edges of the first and second screens, and at least one chord keyboard comprising keys, fixed to at least one of the outer edges of the screens in such a position as to be gripped by the user while holding the device so as to view the first and second screens, and which keyboard is coupled to provide input to the processor responsive to pressure exerted on the keys by the user.

Further in accordance with a preferred embodiment of the present invention, the data displayed on the second screen is different from the data displayed on the first screen.

Still further in accordance with a preferred embodiment of the present invention, the device includes two chord keyboard, fixed to the respective outer edges of the first and second screens.

Still further in accordance with a preferred embodiment of the present invention, pressure exerted on the keys of both chord keyboards in coordination generates an input signal to the processor representing an alphanumeric character or processing instruction.

Additionally in accordance with a preferred embodiment of the present invention, the two keyboards are operable in alternation to input alphanumeric characters or processing instruction to the processor.

Also in accordance with a preferred embodiment of the present invention, one of the two keyboards further includes a pointing device.

Further in accordance with a preferred embodiment of the present invention, the pointing device is operable by a thumb of the user while gripping the one of the two keyboards.

Still further in accordance with a preferred embodiment of the present invention, the keys are positioned at the rear of the screen for operation by the user's fingers.

Additionally in accordance with a preferred embodiment of the present invention, the keys are positioned so that each of the keys is preferentially operated by a specific one of the user's fingers.

Also in accordance with a preferred embodiment of the present invention, the at least one chord keyboard includes at least one thumb key positioned at the front of the screen for operation by the user's thumb.

Further in accordance with a preferred embodiment of the present invention, the at least one thumb key comprises two thumb keys.

Still further in accordance with a preferred embodiment of the present invention, pressure exerted on the keys generates an input to the processor representing an alphanumeric character or processing instruction.

Also in accordance with a preferred embodiment of the present invention, the device includes a single chord keyboard positioned at the outer edge of the first screen and a handgrip positioned at the outer edge of the second screen.

Also in accordance with a preferred embodiment of the present invention, the handgrip includes a pointing device, which is operable by the user while gripping the handgrip.

Further in accordance with a preferred embodiment of the present invention, the pointing device is selected from the group consisting of a joystick, a thumb-button, a pressure-sensitive knob, and a pressure sensitive hand-grip.

Still further in accordance with a preferred embodiment of the present invention, the device also includes at least one armrest, which is fixed to the at least one outer edge of the screens, in such a position that the user can rest an arm, wrist or hand thereupon, while gripping the at least one chord keyboard.

Additionally in accordance with a preferred embodiment of the present invention, the at least one chord keyboard is configured to be detached from the at least one outer edge of the screens, and reattached thereto by the user.

Also in accordance with a preferred embodiment of the present invention, the at least one chord keyboard is configured to be moved along the at least one outer edge of the screens by the user, so as to provide input to the processor from multiple positions along the outer edge.

There is further provided in accordance with another preferred embodiment of the present invention, a method of inputting and displaying data on a computing device that includes a processor and a display screen coupled to be driven by the processor to display data to a user of the device. The method includes fixing at least one chord keyboard to a side of the screen so as to be gripped by the user while holding the computing device with both hands, one at either side of the screen, and viewing the screen, sensing pressure exerted by the user on the keys of the at least one chord keyboard so as to provide input to the processor, and displaying data on the screen, to the user of the device, responsive to the input to the processor.

Further in accordance with a preferred embodiment of the present invention, sensing the pressure includes generating the input to the processor representing an alphanumeric character or processing instruction.

Still further in accordance with a preferred embodiment of the present invention, the method also includes resting at least one arm, wrist or hand on at least one corresponding armrest, which is fixed to a side of the screen.

### BRIEF DESCRIPTION OF THE DRAWINGS

The present invention will be understood and appreciated more fully from the following detailed description, taken in conjunction with the drawings in which:

FIG. 1A is a schematic, overhead view of a user holding a computing device with a single chord keyboard and a handgrip, constructed and operative in accordance with a preferred embodiment of the present invention;

FIG. 1B is a schematic rear view of the computing device of FIG. 1A, constructed and operative in accordance with a preferred embodiment of the present invention;

FIG. 2 is a schematic front view of a computing device with two chord keyboards, one on either side of the screen, constructed and operative in accordance with a preferred embodiment of the present invention;

FIG. 3 is a schematic front view of a computing device with a chord keyboard and a pointer handgrip, constructed and operative in accordance with another preferred embodiment of the present invention;

FIG. 4A is a schematic illustration of a computing device having two connected adjacent screens and two chord keyboards on the non-connecting edges of the adjacent screens, in an open position, constructed and operative in accordance with a preferred embodiment of the present invention;

FIG. 4B is a schematic view of the computing device of FIG. 4A in an almost closed position; and

FIG. 5 is a simplified illustration of the computing device of FIG. 2, with armrests positioned on either side of the screen, constructed and operative in accordance with a preferred embodiment of the present invention.

### DETAILED DESCRIPTION OF PREFERRED EMBODIMENTS

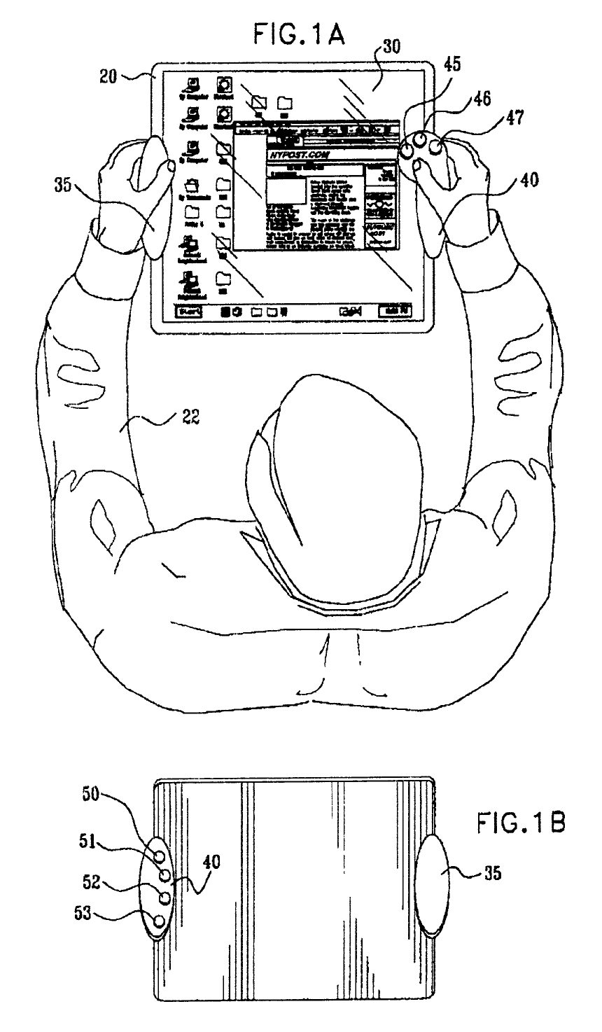

Reference is now made to FIG. 1A, which is a simplified schematic illustration of a user 22 holding a computing device 20 with a single chord keyboard 40 and a handgrip 35, one on either side of a screen 30, constructed and operative in accordance with a preferred embodiment of the present invention. Computing device 20 is preferably similar in capabilities and computing power to computing devices known in the art, such as portable or laptop computers, in that it comprises a processor (not shown) and screen 30 for displaying information, such as verbal, pictorial, graphical or mathematical information, to user 22. Screen 30 is located on the front exterior side of computing device 20, with the processor typically positioned inside the device, behind screen 30. The screen preferably has a resolution of at least 500×500 pixels, so that the user can conveniently run substantially any personal computer application on the device. Chord keyboard 40 also acts as a handgrip, allowing a user to hold device 20 in both hands, at handgrip 35 and at chord keyboard 40, so as to be able to view screen 30 while holding device 20. Chord keyboard 40 preferably is ergonomically shaped so as to allow a secure and comfortable grip to users with a range of hand-sizes.

User 22 typically holds computing device 20 from the front, so as to view screen 30, with four fingers of each hand gripping behind device 20 and the thumbs gripping at the front. Chord keyboard 40 preferably comprises a plurality of keys located both at the front and the rear of device 20. Shown in FIG. 1A are thumb keys 45, 46, 47 positioned to be pressed by the thumb of user 22 while holding device 20 at chord keyboard 40, with his right hand.

Reference is now made to FIG. 1B which is a schematic rear view of the computing device of FIG. 1A, constructed and operative in accordance with a preferred embodiment of the present invention. On the rear of chord keyboard 40, at the rear of device 20, are finger keys 50, 51, 52, 53 positioned to be pressed by the fingers of a user while holding device 20 at chord keyboard 40. In the embodiment of FIG. 1B, chord keyboard 40 comprises four finger keys 50, 51, 52, 53, each positioned to be pressed by a specific one of a user's fingers. In an alternative embodiment, chord keyboard 40 comprises more than four finger keys, with more than one finger key positioned to be pressed by a specific one of a user's fingers.

Chord keyboard 40 functions as an input mechanism for the processor in device 20, for use by the user while holding device 20 with both hands at handgrip 35 and at chord keyboard 40, so as to be able to view screen 30. The user inputs characters via chord keyboard 40 using any suitable coding system for chording of the characters, such as the systems used in chord keyboards known in the art, such as those described in the Background of the Invention.

Optionally, chord keyboard 40 and handgrip 35 may be detachable from, and attachable to, device 20. Once detached, chord keyboard 40 may be attached in place of handgrip 35, or handgrip 35 may be attached in place of chord keyboard 40, allowing interchangeability between left-handed and right-handed use of chord keyboard 40. Additionally or alternatively, chord keyboard 40 may be movable along the edge of device 20 so as to be fixed in place at a user's preferred position relative to screen 30.

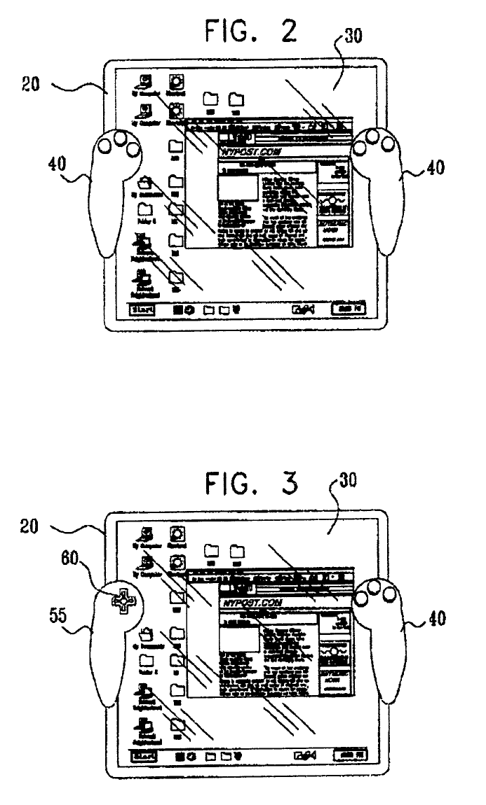

Reference is now made to FIG. 2 which is a simplified schematic front view of computing device 20 with two chord keyboard handgrips 40, one on either side of screen 30, constructed and operative in accordance with another preferred embodiment of the present invention. Each of chord keyboards 40 may be used independently as an input device for processor 25 as described above. The user may operate the two keyboards in alternation in order to increase the rate of input to processor 25.

In an alternative embodiment, the two chord keyboards 40 may chord in coordination such that the pressing of a combination of up to ten keys simultaneously generates an input representing different characters or instructions. This embodiment allows a much greater range of characters and symbols to be input to the processor. Preferably, a hardware or software switch is provided to switch between the independent and coordinate modes of two-handed operation.

In a further alternative embodiment, one of chord keyboards 40 is used to generate signals representing alphanumeric characters, while the second chord keyboard generates processing or control signals, in an analogous manner to the “shift”, “alt” and “control” keys on a standard keyboard.

Reference is now made to FIG. 3 which is a schematic front view of computing device 20 with chord keyboard 40 and a pointer handgrip 55, one on either side of the screen, constructed and operative in accordance with another preferred embodiment of the present invention. Device 20 can be held by a user in both hands, at pointer handgrip 55 and at chord keyboard 40, so as to be able to view screen 30 while holding device 20. Pointer handgrip 55 typically comprises a pointing device 60, which functions like a mouse for manipulating a cursor on screen 30. Pointing device 60 may comprise any suitable pointing device known in the art, such as a joystick, a thumb button (a depressed button for control by rotational pressure of the thumb), or a pressure-sensitive knob such as the TrackPoint device provided in some portable computers, such as the IBM ThinkPad™. Alternatively, the pointer handgrip may comprise a pressure sensitive hand-grip, which responds to directional pressure by the entire hand.

In another preferred embodiment, pointer handgrip 55 may comprise a functional mixture of a chord keyboard and a pointing device. For example, pointer handgrip 55 may comprise finger keys at the rear of device 20, as shown above in FIG. 1B, while the thumb keys of chord keyboard 40 are replaced by pointing device 60.

Prior art portable or laptop computers typically fold open vertically to expose an internal keyboard and display screen. Computing devices comprising at least one chord keyboard at the edge thereof, constructed and operative in accordance with a preferred embodiment of the present invention, do not require that a regular keyboard be attached thereto. This reduces the weight and size of computing devices of preferred embodiments of the present invention relative to conventional prior art computing devices, which allows the addition of extra functionalities to portable computers, while maintaining portability.

Alternatively, computing devices of preferred embodiments of the present invention, may comprise a regular keyboard, preferably detachable from the computing device, in addition to the at least one chord keyboard.

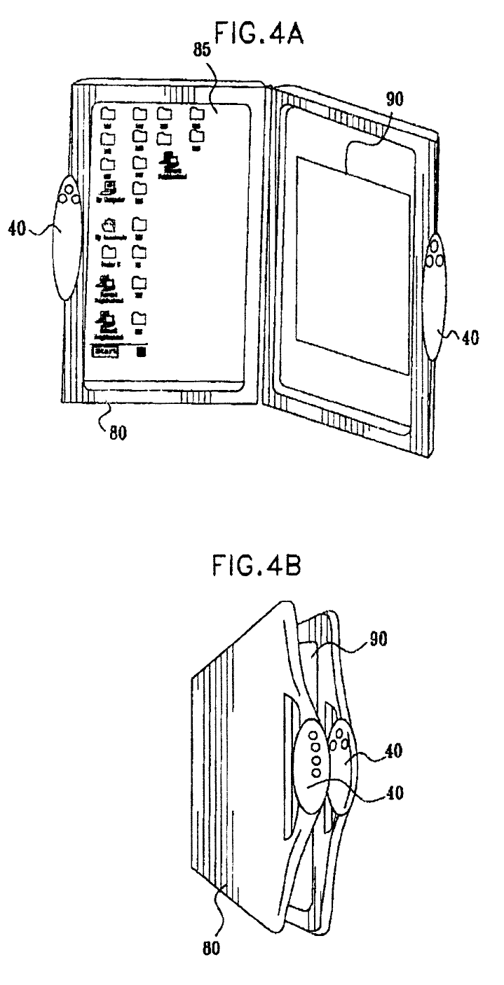

Reference is now made to FIGS. 4A and 4B which are schematic illustrations of a computing device 80 which folds open to expose two connected adjacent screens 85, 90 and two chord keyboards 40 on the non-connecting edges of adjacent screens 85, 90, constructed and operative in accordance with a preferred embodiment of the present invention. In FIG. 4A the computing device is shown in an open configuration, while in FIG. 4B, the same device is shown in an almost closed configuration. Device 80 may comprise two chord keyboards 40 as shown in FIG. 4A. Alternatively, device 80 may comprise one chord keyboard 40 and one handgrip 35 or pointer handgrip 55. Device 80 can be held by a user in both hands, so as to be able to view screen 30 while holding device 80.

The displays on the two screens of the computing device of FIGS. 4A and 4B are typically different from each other. For example, one screen may show icons and text, while the second screen displays graphic application data, such as images.

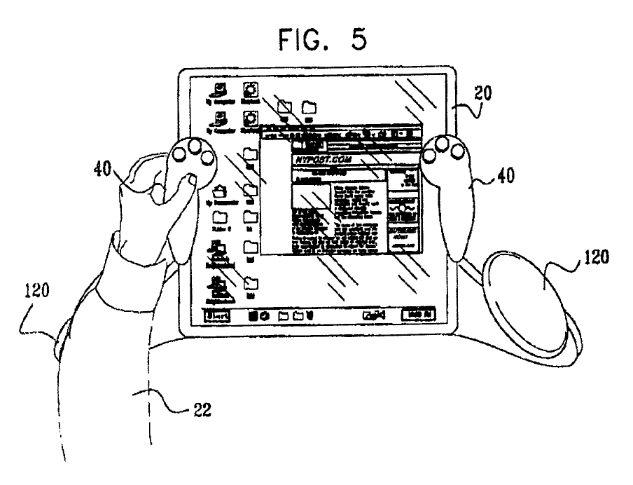

It is appreciated that computing devices comprising at least one chord keyboard attached at the edge thereof, constructed and operative in accordance with a preferred embodiment of the present invention, do not need to be opened on a flat surface for use, and can be used in minimal spaces while being held by a sitting or standing user. Such computing devices are typically held in a very comfortable and natural position, such as that used when holding as book. It is further appreciated that to take some of the weight of the computing device from off the arms or shoulders of its user, the lower edge of the device can be rested on any convenient surface. To support the arms of the user, the computing device may also comprise at least one arm-rest as described below with reference to FIG. 5.

Reference is now made to FIG. 5 which is a simplified schematic illustration of the computing device of FIG. 2, with armrests 120 positioned on either side of the screen, to support the lower arms, wrists or hands of user 22 while holding chord keyboards 40, constructed and operative in accordance with a preferred embodiment of the present invention. Alternatively, device 20 may comprise one chord keyboard 40 and one handgrip 35 or pointer handgrip 55. Armrests 120 may be detachable from device 20. Alternatively or additionally, armrests 120 may be flexibly-connected to the edge of device 20, and may fold over in front of, or behind, device 20 when not in use.

It will be appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

What is claimed is:

1. A computing device, comprising:
a processor;
a screen, which is coupled to be driven by the processor to display data to a user of the device, and which is arranged so as to be viewable by a user of the device while holding the device with both hands, one at either side of the screen; and
at least one chord keyboard comprising keys, which is fixed to a side of the screen in such a position as to be gripped by the user while holding the device so as to view the screen, and which is coupled to provide input to the processor responsive to pressure exerted on the keys by the user.

2. A device according to claim 1 wherein the at least one chord keyboard comprises two chord keyboards, one at either side of the screen.

3. A device according to claim 2, wherein pressure exerted on the keys of both chord keyboards in coordination generates an input signal to the processor representing an alphanumeric character or processing instruction.

4. A device according to claim 2, wherein the two keyboards are operable in alternation to input alphanumeric characters or processing instruction to the processor.

5. A device according to claim 2, wherein one of the two keyboards further comprises a pointing device.

6. A device according to claim 10, wherein the pointing device is operable by a thumb of the user while gripping the one of the two keyboards.

7. A device according to claim 1 wherein the keys are positioned at the rear of the screen for operation by the user's fingers.

8. A device according to claim 7 wherein the keys are positioned so that each of the keys is preferentially operated by a specific one of the user's fingers.

9. A device according to claim 1 wherein the at least one chord keyboard comprises at least one thumb key positioned at the front of the screen for operation by the user's thumb.

10. A device according to claim 9 wherein the at least one thumb key comprises two thumb keys.

11. A device according to claim 1 wherein pressure exerted on the keys generates an input to the processor representing an alphanumeric character or processing instruction.

12. A device according to claim 1, and comprising a handgrip, fixed to the side of the screen opposite the chord keyboard.

13. A device according to claim 12, wherein the handgrip comprises a pointing device, which is operable by the user while gripping the handgrip.

14. A device according to claim 13 wherein the pointing device is selected from the group consisting of a joystick, a thumb-button, a pressure-sensitive knob, and a pressure sensitive hand-grip.

15. A device according to claim 1 and also comprising at least one armrest, which is fixed to a side of the screen in such a position that the user can rest an arm, wrist or hand thereupon, while gripping the at least one chord keyboard.

16. A device according to claim 1, wherein the at least one chord keyboard is configured to be detached from the screen and reattached thereto by the user.

17. A device according to claim 1, wherein the at least one chord keyboard is configured to be moved along an edge of the screen by the user, so as to provide input to the processor from multiple positions along the edge.

18. A computing device, comprising:
a processor;
adjacent first and second screens, having respective inner and outer edges, wherein the screens are connected to one another at the inner edges thereof, wherein the first and second screens are coupled to be driven by the processor to display data to a user of the device and are arranged so as to be viewable by the user while holding the device with both hands, one at either side of the device at the outer edges of the first and second screens; and
at least one chord keyboard comprising keys, fixed to at least one of the outer edges of the screens in such a position as to be gripped by the user while holding the device so as to view the first and second screens, and which keyboard is coupled to provide input to the processor responsive to pressure exerted on the keys by the user.

19. A device according to claim 18 wherein the data displayed on the second screen is different from the data displayed on the first screen.

20. A device according to claim 18 wherein the at least one chord keyboard comprises two chord keyboards, fixed to the respective outer edges of the first and second screens.

21. A device according to claim 20, wherein pressure exerted on the keys of both chord keyboards in coordination generates an input signal to the processor representing an alphanumeric character or processing instruction.

22. A device according to claim 20 wherein the two keyboards are operable in alternation to input alphanumeric characters or processing instructions to the processor.

23. A device according to claim 20, wherein one of the two keyboards further comprises a pointing device.

24. A device according to claim 23, wherein the pointing device is operable by a thumb of the user while gripping the one of the two keyboards.

25. A device according to claim 18 wherein the keys are positioned at the rear of the device for operation by the user's fingers.

26. A device according to claim 25 wherein the keys are positioned so that each of the keys is preferentially operated by a specific one of the user's fingers.

27. A device according to claim 18 wherein the at least one chord keyboard comprises at least one thumb key positioned at the front of the device for operation by the user's thumb.

28. A device according to claim 27 wherein the at least one thumb key comprises two thumb keys.

29. A device according to claim 18 wherein pressure exerted on the keys generates an input to the processor representing an alphanumeric character or processing instruction.

30. A device according to claim 18, comprising a single chord keyboard positioned at the outer edge of the first screen and a handgrip positioned at the outer edge of the second screen.

31. A device according to claim 30 wherein the handgrip comprises a pointing device, which is operable by the user while gripping the handgrip.

32. A device according to claim 31 wherein the pointing device is selected from the group consisting of a joystick, a thumb-button, a pressure-sensitive knob, and a pressure sensitive hand-grip.

33. A device according to claim 18 and also comprising at least one armrest, which is fixed to the at least one outer edge of the screens, in such a position that the user can rest an arm, wrist or hand thereupon, while gripping the at least one chord keyboard.

34. A device according to claim 18, wherein the at least one chord keyboard is configured to be detached from the at least one outer edge of the screens, and reattached thereto by the user.

35. A device according to claim 18, wherein the at least one chord keyboard is configured to be moved along the at least one outer edge of the screens by the user, so as to provide input to the processor from multiple positions along the outer edge.

36. A method of inputting and displaying data on a computing device that includes a processor and a display screen coupled to be driven by the processor to display data to a user of the device, the method comprising:
fixing at least one chord keyboard to a side of the screen so as to be gripped by the user while holding the computing device with both hands, one at either side of the screen, and viewing the screen;
sensing pressure exerted by the user on the keys of the at least one chord keyboard so as to provide input to the processor; and
displaying data on the screen, to the user of the device, responsive to the input to the processor.

37. A method according to claim 36 wherein sensing the pressure comprises generating the input to the processor representing an alphanumeric character or processing instruction.

38. A method according to claim 36 and also comprising resting at least one arm, wrist or hand on at least one corresponding armrest, which is fixed to a side of the screen.
